(19) United States
(12) Patent Application Publication
(10) Pub. No.: US 2002/0165641 A1
(43) Pub. Date: Nov. 7, 2002

(54) Medical cart with electronically lockable pharmaceutical and narcotic drawers

(75) Inventors: Edwin Dizon Manalang, Burbank, IL (US); Andrew Romaen, Chicago, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Homak Manufacturing Co., Inc.

(21) Appl. No.: 10/132,119

(22) Filed: Apr. 25, 2002

Related U.S. Application Data
(60) Provisional application No. 60/286,463, filed on Apr. 25, 2001.

(51) Int. Cl. G06F 17/00

(52) U.S. Cl. 700/237; 312/1

(57) ABSTRACT

A medical cart is provided with a keyless locking system for drawers containing narcotics and for other drawers containing pharmaceuticals. Some personnel may be authorized with codes to open both the narcotics and pharmaceutical drawers while other personnel may have codes that open the pharmaceutical drawers but do not open the narcotics drawers. Preferably, an audit trail is provided to know who had or tried to access the drawers and when the access was attempted and accomplished. To this end there is a memory store and read-out port that allows downloading or read-out of the audit trail. The medical cart has a simplified locking system with fewer and more reliable components comprising cam operated locking bars that operate locking rods that latch with latch portions on the slidable drawers in the cart. The drawers may be automatically locked upon slamming them to a closed position. Preferably, an associated timer causes an automatic relocking operation or a lock switch may be operated to set the locking mechanism to lock the drawer when it is pushed into its closed position. Also, a light source may be provided to illuminate the control panel and drawers. A motion sensor may switch the light off when the cart is put in motion. A light level sensor may sense the ambient light level and switch the light on when the cart enters a darkened room. A mechanical override may be provided to allow access to the contents in the drawers in the event of electronic failure.

This application claims the benefit of Provisional Application No. 60/286,463, filed Apr. 25, 2001.

### FIELD OF THE INVENTION

This invention relates to a medical cart having lockable bins or drawers for holding pharmaceuticals and narcotics.

### BACKGROUND OF THE INVENTION

Currently, in hospitals or other medical facilities medical carts mounted on wheels are positioned where needed and have an electronic keypad or other kind of electronic operated device that is operated by medical personnel to unlock the bins or drawers on the cart to allow access to the contents. Often, it is desired to have narcotics on the medical cart and these narcotics are kept in a separate narcotics drawer from the pharmaceuticals that are kept in other drawers. Heretofore, such narcotic drawers were locked mechanically as with a key lock. While there are medical carts in use with an electronic keypad, they unlock the narcotics drawer with the other drawers. There may be instances, where it is desirable that only certain authorized personnel are allowed access to prescription drugs in the pharmaceutical drawers but they are not authorized to access the narcotics in the narcotics drawer. Thus, there is a need for a medical cart that has a separate electronic locking of the narcotics and the pharmaceutical drawers to allow access to the narcotics only by persons specifically authorized to dispense narcotics.

Heretofore, the medical carts have had relatively complicated locking mechanisms with many parts which often required maintenance to keep them operating correctly. Also, the locking mechanisms were relatively expensive because of their complexity. Thus, there is a need for a new simplified and less expensive locking system.

In handling medications, there is often a need, particularly for access to and dispensing of narcotics, that there be an audit trail to allow managers to know who has accessed the narcotics and on what date and time. Current medical carts lack any audit trail capability and hence there is a need for providing such on a medical cart.

### SUMMARY OF THE INVENTION

In accordance with the present invention, there is provided a new and improved medical cart, as contrasted with the prior art, having a separate electronically operated locking device for the narcotics drawer. Thus, the pharmaceutical drawers may be opened by personnel for accessing the drugs therein; but these personnel may not have authority to access the narcotics so the narcotics drawer will remain locked even though the pharmaceutical drawers are unlocked. On the other hand, certain medical personnel may be authorized to dispense both pharmaceuticals and narcotics and may want to open both kinds of drawers and such persons are provided access upon a proper input of a code on a control panel for the narcotics. The preferred invention provides a keyless unlocking of the non-narcotic medication containing drawers and a keyless unlocking of the narcotic containing drawer.

Particularly, with narcotics or other medications, management may want to have audit trail to know who had access to the narcotics and when. In accordance with another important aspect of the invention, there is provided an entry log stored to identify persons accessing or trying to access the drawers in the cart. More specifically, each person may have an identifying code, e.g., a pin number; and a memory store in the cart is associated with the computer stores the person's identity code, the date, and time of access to the narcotics for a later read-out. In the preferred embodiment of the invention, the cart has a read-out or downloading port that connects to the memory store and allows read-out of the person, the date and time of access to the narcotics drawer and/or other medication drawers to provide the desired audit trail. The read-out information may be sent to a printer or downloaded into a notebook computer. The pre-programmed code inputted by the person preferably identifies the person such as by a pin number as well as causes an unlocking operation of the drawers when a proper preprogrammed code is inputted. The computer system stores the identify of the proper coded input, the date and the time for each access to medications an/or narcotics and thereby provides an audit printout capability of the date, time and operator codes whenever the cart is unlocked and/or locked.

In accordance with an important aspect of the invention, the medical cart is provided with a simplified locking system as contrasted to the locking system used heretofore in medical carts, in that it has fewer operating components and is reliable in operation thereby lessening the need for maintenance and/or repair. In the preferred embodiment, this is achieved by the use of cam operated lock bars that operate locking rods that latch with latches on the slidable drawers. Preferably, the latch bars are operated by cams mounted on a shaft which may be turned to lift the latch bars and unlock the latch bars. The cams may be mounted on a shaft turned by an electric motor which is operated by the controller or computer system, which includes a central processor unit (CPU). This preferred locking mechanism may also be manually operated as by use of a key, in a mechanical only version of the medical cart. The narcotics drawer may be double-locked if desired to provide added security. Also, if the power fails, a mechanical turning of the shaft may be used to open the drawers.

In accordance with a further aspect of the invention, the drawers and bins are adapted to be slammed shut and automatically relocked. Preferably, the electronic operator or controller has an associated timer or timing device that, upon expiration of a set of predetermined time interval, causes an automatic relocking operation shifting of the locking devices to the locking position locking all of the drawers that are closed. If a drawer is left open, usually inadvertently after the timer has timed out, the drawer need merely be pushed closed with a good force to cause it to be automatically slam locked. In the illustrated embodiment of the invention, the locking devices includes a pair of cooperating locking elements one of which has a camming portion preferably in the shape of a wedge to shift relative to a locking rod to lock the drawer when it is slammed shut. Herein, the power for the electronic devices and motors is from a rechargeable battery carried on the cart.

A still further locking operation may be provided in that a manually operated switch, such as a “lock” push button may be provided such that operation of the lock push button results in an automatic locking of the closed drawers. That is, after pushing of the lock switch those drawers that are in the closed position will be locked and those drawers still open and then slid to the closed position will also be automatically relocked.

In accordance with an important aspect of the invention, the medical cart is provided with a light source that illuminates the control panel and the bins to allow identification of and removal of the medicine from a bin in a darkened hospital room. Preferably, the light also illuminates the area around the cart to assist in shifting of the cart's position and travel. Thus, the patient need not be awakened by turning on the room light in order to use or move the cart. Preferably, the light source is also controlled automatically by sensors such as a motion sensor that detects movement of the cart and automatically switches on the light when the cart is put in motion and the light switch is positioned for automatic control. Another sensor may be a light level sensor that senses the ambient light level and switches the light source on when entering a dark room and switches the light source off when moving into an ambient bright light area.

In the preferred embodiment of the invention, the medical cart has a keypad and associated computer or controller in the form of electronic operator and also may have a removable cassette that has rows of small bins or drawers therein. The narcotics drawer is separate from the cassette. The preferred locking devices include a driven cam shaft capable of driving a locking bar in opposite directions in order to either lock or unlock the drawers. In the illustrated embodiment of the invention, an electric motor drive is used to turn the cam shaft to operate a latch lifter which shifts a locking rod upwardly from holding and restraining engagement with a wedge-shaped cooperating, latch element to release the bins in the cassettes for being pulled open. In this embodiment, the proper operational sequence of keys on the keypad is made to cause the computer to operate the motor driven cam shaft to shift both locking bars to unlock the narcotics drawer and the medication drawer.

In the preferred embodiment of the invention, one input code is inputted by persons to access the pharmaceutical drawers only. A second input code, in addition to the first input code, must be inputted to allow access to the narcotic drawer. Herein, the narcotic drawer is locked by two locking bars and the first coded input causes the electronic operator to shift the pharmaceutical, associated lock bar to an unlocking position and then the second input code causes the electronic operator to shift the narcotics, associated lock bar to the unlocking position thereby allowing access to the narcotics drawer.

In the preferred embodiment of the invention, it is preferred to provide a mechanical override that allows access to the slidable drawers in the event of an electronic failure or for some other reason. The preferred mechanical override comprises a key operated kind of lock override that must be unlocked by a mechanical key. Herein, the key not only does the unlocking but also may be used to shift the locking bars to the unlocking position.

### BRIEF DESCRIPTION OF THE DRAWINGS

FIG. 1 is a perspective view of a medical cart having electronic locking of the narcotic and non-narcotic bins or drawers;

FIG. 2 is a rear view showing internally within the medical cart the locking mechanisms driven by twin motors operated by the keypad electronic operator to unlock or lock separately the narcotics and non-narcotic drawers;

FIG. 3 is a rear view of a cassette having two rows of non-narcotic bins showing the cooperating locking elements in the form of rods and wedge-shaped blocks;

FIG. 4 is a front view of the cassette of FIG. 3;

FIG. 5 is a perspective view of another embodiment of the invention having cassettes that extend the width of the medical cart;

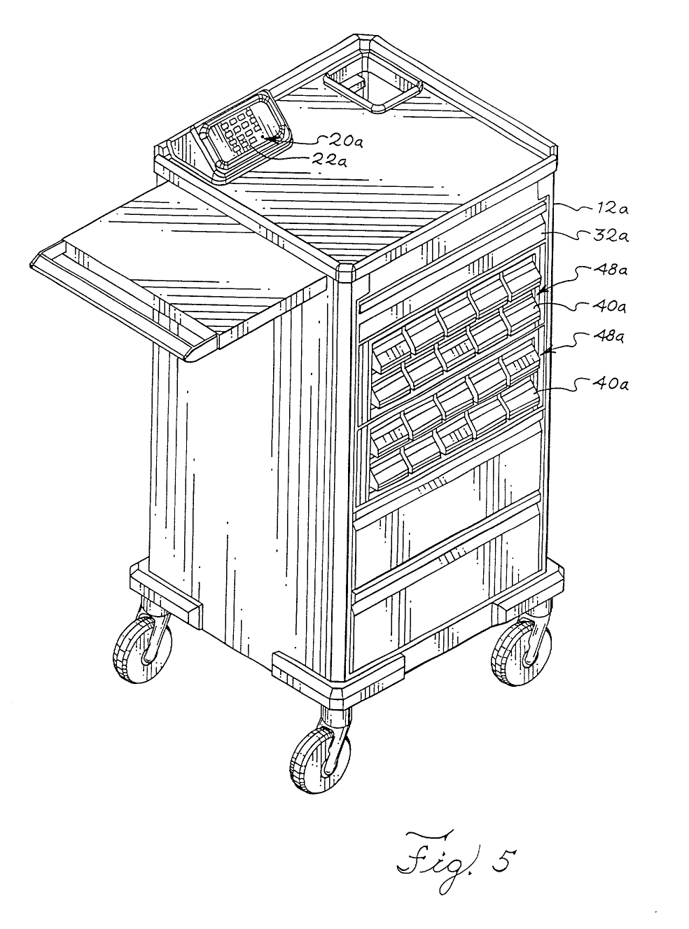

FIG. 6 is a perspective view of another embodiment of the invention which is shorter in width than the embodiment of FIGS. 1 and 5;

FIG. 7 is a perspective view of a medical cart which is similar to that illustrated in FIG. 6, but which is wider than the medical cart shown in FIG. 6;

FIG. 8 is a rear view similar to that of FIG. 2 showing the locking mechanism, the CPU module, and a mechanical override;

FIG. 9 is a rear view similar to FIG. 3 of a cassette;

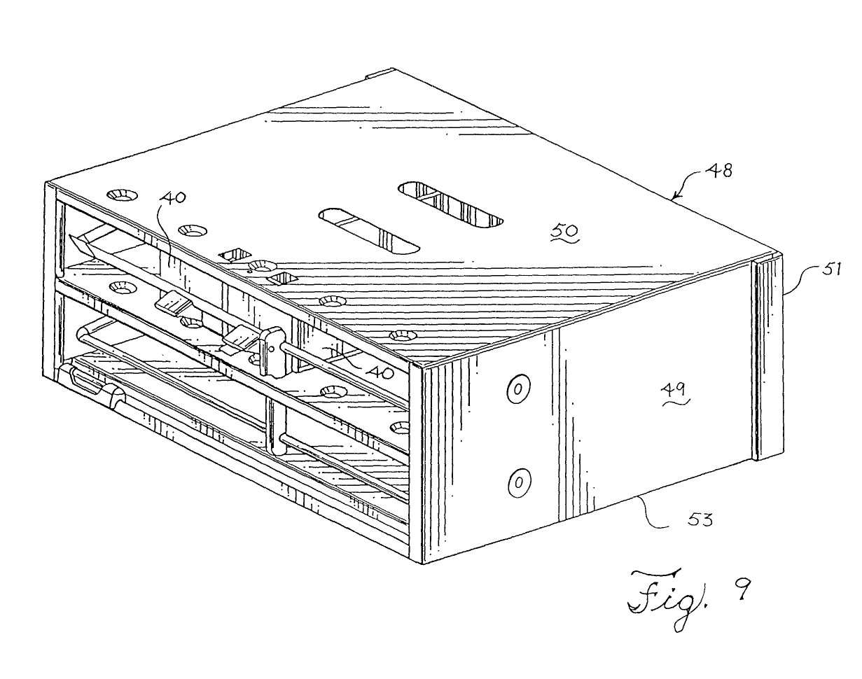

FIG. 10 is an enlarged view of the control panel including the keypad for the medical cart;

FIG. 11 is a rear perspective view of a cam shaft module and an electrical module used in the preferred embodiment of the invention; and

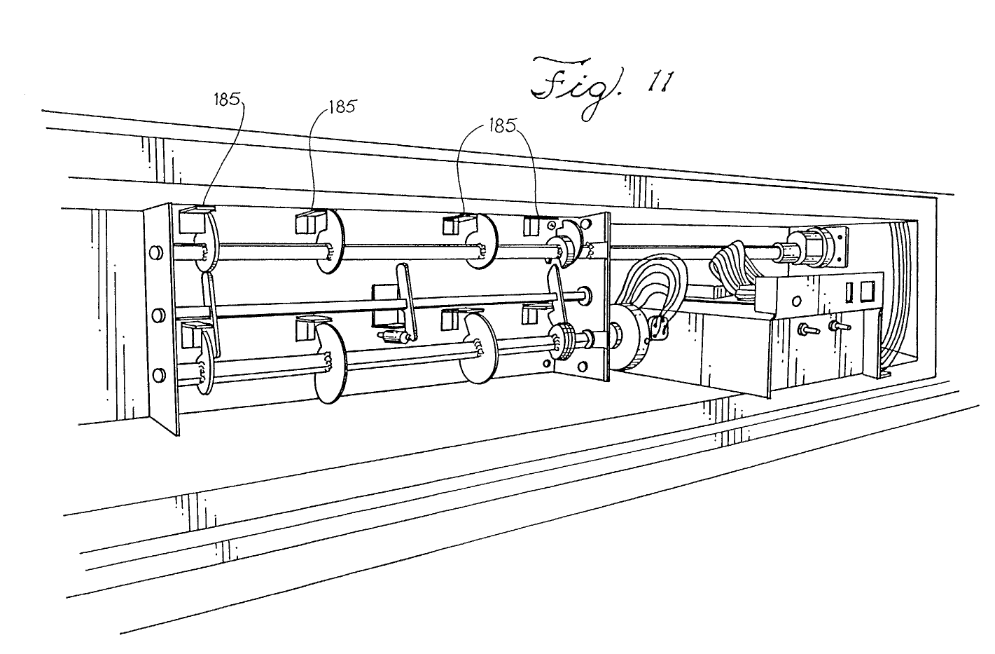

FIG. 12 is a block diagram of the apparatus in the medical cart.

### DETAILED DESCRIPTION OF THE PREFERRED EMBODIMENT

As shown in the drawings for purposes of illustration, the invention is embodied in a medical cart 10 having a main body or housing 12 which is preferably mounted on wheels or rollers 14 for assisting in moving the cart from one location to another. The cart housing 12 has an upper or top wall 16 on which is mounted an electronic operator 20 comprising an electrical control panel 21 having a keypad 22 having keys for operating an internal locking system. The cart also has a vertical housing side walls 30 attached to a front wall 31 and to a back wall. A sliding tray 26 may be slid into and from the housing and includes an outer handle 28 pushing the tray inward or pulling outward of the housing. The front housing wall 31 has an open front face providing access to drawers and bins.

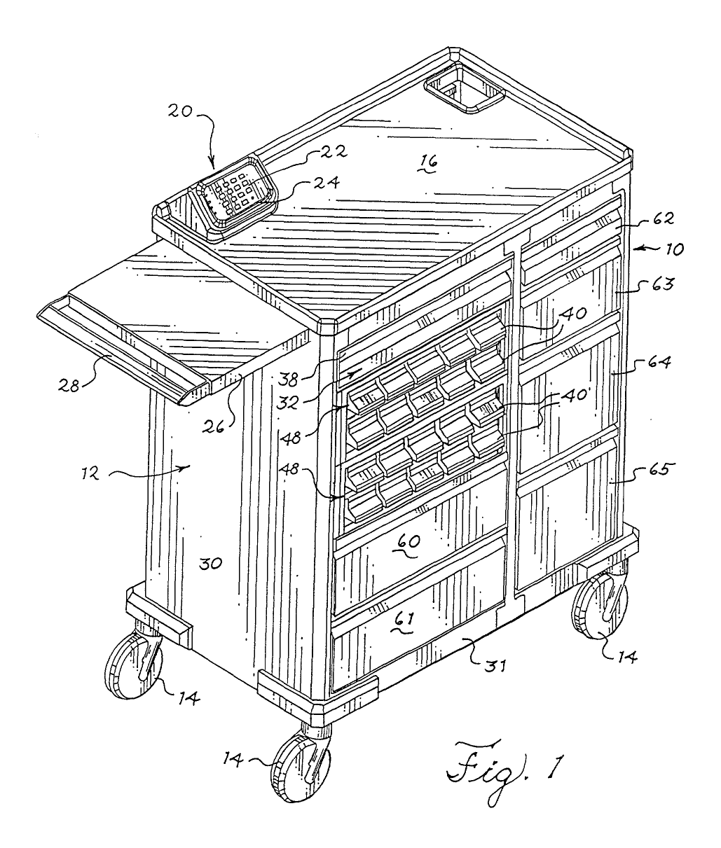

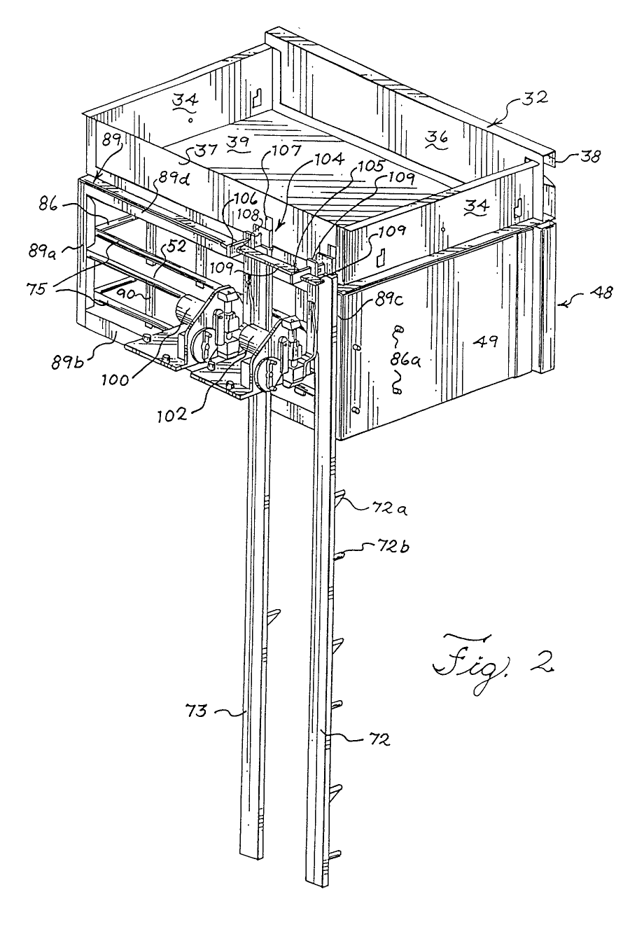

In the illustrated medical cart there is a narcotics drawer 32 (FIGS. 1 and 2) that is slidably mounted by slides on side walls 34. The narcotic drawer has a front panel 36 with a handle 38 and a bottom panel 39. A rear vertical panel 37 cooperates with a locking device to lock the slidable narcotics drawer in its closed position, as illustrated in FIG. 1, in which the previously opened top of the drawer is covered by the upper part of the cart. The slidable drawer 32 may be pulled outwardly from the cart when in its unlocked position or condition.

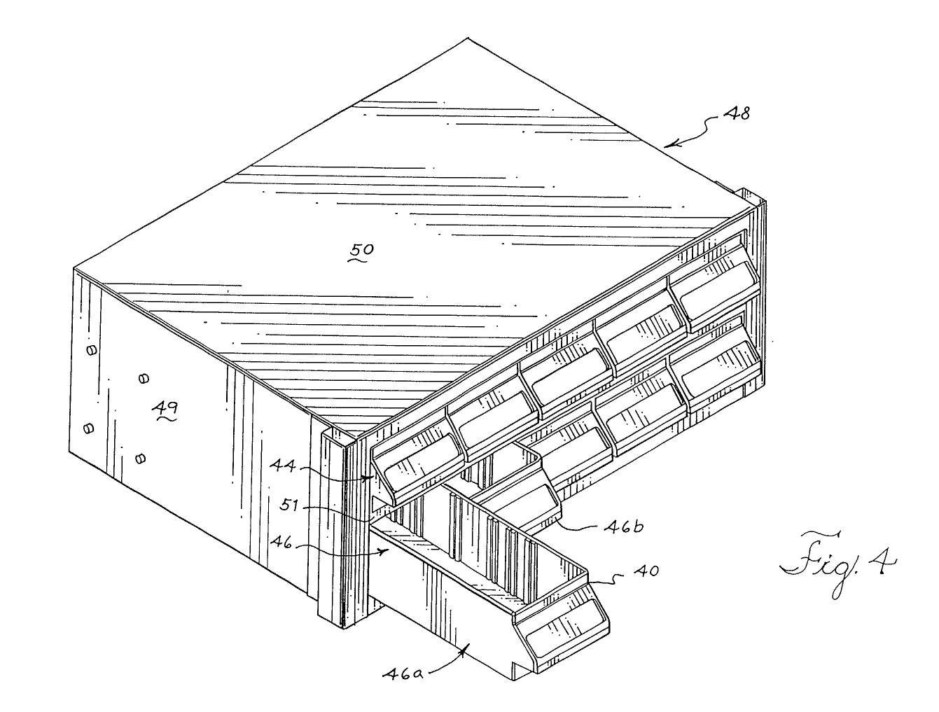

Also, the medical cart contains non-narcotic drawers or bins 40 that are slidable between closed positions and open positions such as shown in FIG. 4. The non-narcotic drawers or bins 40 usually contain prescription drugs, pharmaceuticals or the like and the bins 40 are also kept locked in the closed position until the locking mechanism is operated by the electronic operator 20. Preferably, the bins 40 are small slidable bins in double rows 44 and 46 in a cassette 48 that has sidewalls 49, a bottom wall 53 and a top wall 50. The cassette also has a front wall 51 with the bins 44 and 46 slidable between the open and closed positions in openings in the cassette front wall 51. Herein, two cassettes 48 are mounted and vertically spaced in the medical cart shown in FIG. 1 to provide four rows of bins with five bins in each row.

In addition to the above-described drawers, there may be slidable drawers 60-65 (FIG. 1) provided on the medical cart that are also lockable or left unlocked, as may be desired.

The illustrated locking mechanism preferably comprises a motor drive 70 and at least one locking bar 72 that is operated by a rear directional motor drive to shift the cooperable members 74 and 76 relative to each other and from a locking position to an unlocking position with respect to each other. The actual locking mechanism may take different forms but herein it comprises a wedge-shaped block 78 fastened to each a back panel 80 of each slidable bins 40 and a common horizontal locking rod 75 cooperable with the wedge-shaped blocks. Herein, the first locking member 74 has a locking portion in the form of an open groove or slot 82 which receives a locking cylindrical rod portion 84 of the locking rod 75 that is sized to fit in the groove 82. The grooves 82 open upwardly in the wedge-shaped blocks and a common horizontal rod 75 fits in the grooves 82 of each of the blocks 78 in the row; and thus serves to extend across all of the wedge-shaped blocks to simultaneously lock all of the bins in a row. There is a horizontal rod 75 for each of the rows of the bins.

The illustrated second cooperable locking member 76 comprises the rod 75 and integral side arms 86 (FIG. 2) at opposite ends of the horizontal rod with each side arm extending forwardly along and inside of the side walls 23 of the cart housing. The side arms 86 extend to outwardly bent ends 86a that are pivoted or rotated within holes in the opposite, vertical side walls 23.

The rear wall of the cassette comprises an encircling outer strip 89 (FIG. 2) having four joined strip portions 89a, 89b, 89c and 89d. Mounted at the rear of the cassette adjacent the encircling outer strip 89 are four vertical bin stops 90 that are spaced from one another and extend vertically between the cassette top wall 50 and a central wall 52 extending horizontally and parallel to the tope cassette wall 50. Four similar bin stops extend vertically between the central wall 52 and bottom wall 53 of the cassette. The bin stops stop the rearward travel of the bins and when the bins are pushed against the bin stops the grooves 82 in the blocks 74 are aligned with one another and with the rod 75 to receive it to lock the bins 40 in their closed and locked position.

The locking devices also include one or more vertical lock bars 72 and 73 that are guided for vertical sliding movement in the medical cart. Vertically spaced lifters or lifter pins 72a and 72b (FIG. 2) project normal to the bars to extend horizontally to have ends located beneath the horizontal locking rods such that as the lock bars may be lifted upwardly. The lifters 72a and 72b engage and lift the locking rods 75 upwardly from the grooves 82 on the bins as the pivotal locking member 76 has its ends 86a turn in holes in the housing side walls 23.

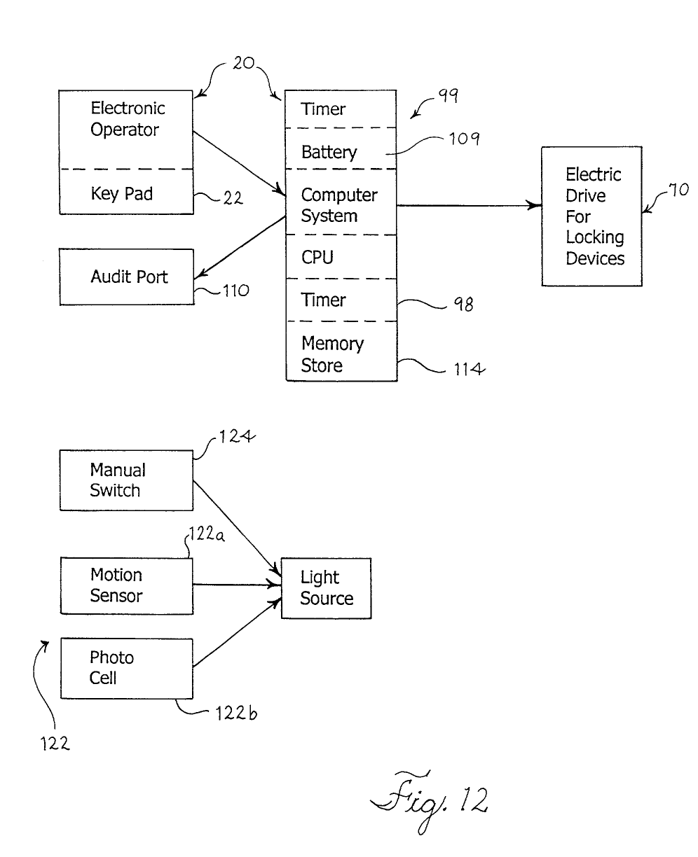

The electronic operator 20 includes a computer or controller 99 (FIG. 12) connected to and operable by the keypad 22 to energize and control the direction of the rotation of a pair of twin electric motors 100 and 102 (FIG. 2) that drive the locking bars up to unlock and down to allow locking. The narcotics drawer 32 is locked by a dual lock device 104 comprising a pair of horizontal lock members 105, 106 removable vertically in vertical slots 107. The inner ends of the lock member 105, 106 may be hooked to the rear wall 37 of the narcotics drawer to hold it in the closed and locked position. The outer rear ends of the lock member 105 and 106 each have a slot 108 with a horizontal bar 109 inserted in the slots 107 in the lock members 105 and 106.

In order to open the narcotics drawers 32 the electronic keypad 22 is operated by punching a sequence of keys 24 on the keypad. The keypad just be operated by a proper sequence to cause the computer to operate both motors 100 and 102 simultaneously to operate the dual locking device 104 to move both the lock members up to the unlocking position to allow the narcotics drawer to be pulled outwardly to an open position allowing access to the narcotics in the drawer. The computer is programmable by the hospital or others to recognize a code or codes to provide access to a medication drawer and a code such as a pin code to identify the person. The computer is also programmed to recognize the code or codes to allow access to the narcotics drawer. The computer is also programmed to log the date, time, and operator codes each time the keypad is operated. On the other hand, when operating the keypad 22 with a certain sequence to open the non-narcotic bins 44, 46 for removal of prescription drugs or the like, only one motor 102 is operated to raise the vertical lock bar 72 to pivot the horizontal locking rod 75 upwardly from the grooves 82 in the wedge-shaped locking members 74 in each row of bins 40. But lifting one of the locking bars is insufficient to unlock the narcotics drawer. Thus, all of the bins in a row are simultaneously unlocked and can be pulled outwardly to dispense the contents in the respective bins.

In the preferred embodiment of the invention, a timing device or timer 98 (FIG. 12) is associated with the electronic operator's computer 99 and upon elapsed of a predetermined period of time, the electric motors 100 and 102 are caused to be energized by the computer to lower the lock bars 72 or 73 and their lifters 72a and 72b to allow the horizontal rods 75 to drop into the grooves 82 in the wedge-shaped blocks 78 on the ends of the non-narcotic bins 44 and 46.

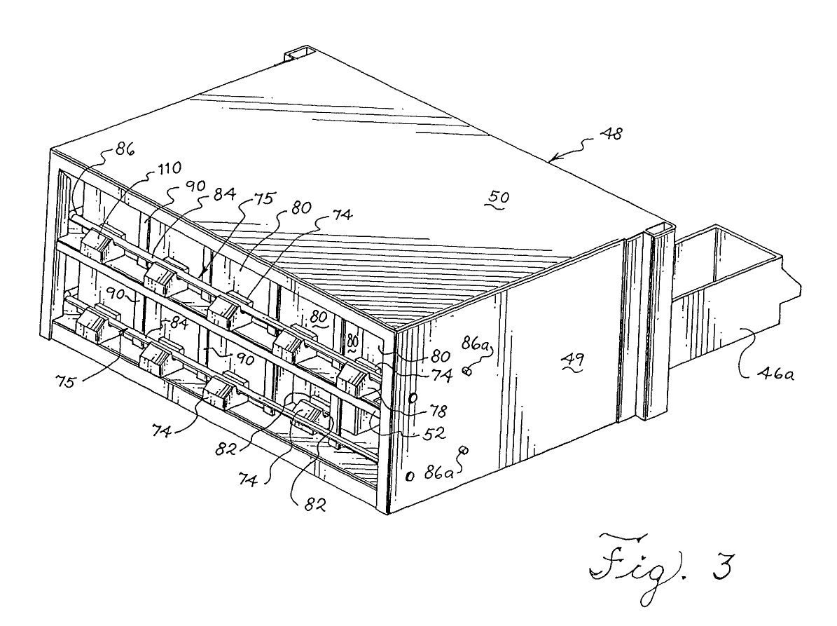

If bins are left open and the predetermined period of time has elapsed and the locking rods 75 have positioned to lock the closed bins and other bins are still in the open position, such as two lower bins 46a and 46b (FIGS. 3 and 4), these unlocked bins 46a and 46b may be slammed to the closed position against bin stops 90 with their grooves 82 aligned to receive the horizontal rod 75. As the wedge-shaped blocks 74 move rearwardly to engage the horizontal rod 75, inclined cam surfaces 110 on the blocks slide under the rod and pivot it upwardly about the pivot ends 86a allowing the block and drawer go continue to slide rearwardly until the grooves 82 in the blocks are aligned with the rod allowing it to drop down into the grooves 82. Thus the drawers may be slammed shut and locked.

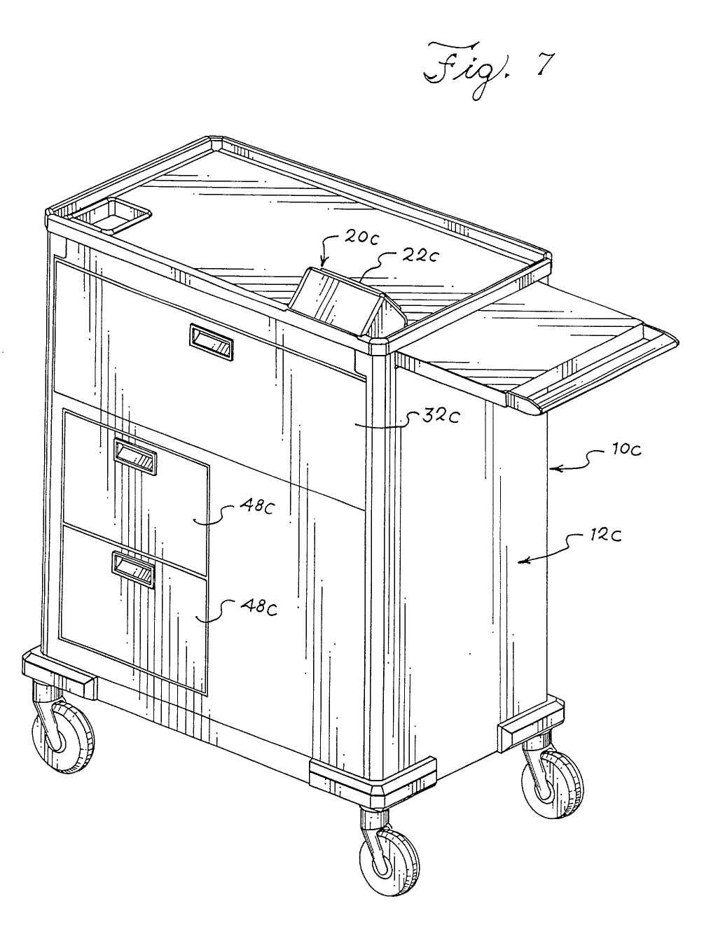

In FIG. 7, there is illustrated a narrow width medical cart 10a having an upper narcotics drawer 32a and two cassettes having bins 48a. The drawer 32a and cassettes extend the width of the cart housing 12a. An electronic operator 20a in the forms of a keypad 22a operates the locking system which may be the same as that described heretofore and hence need not be repeated.

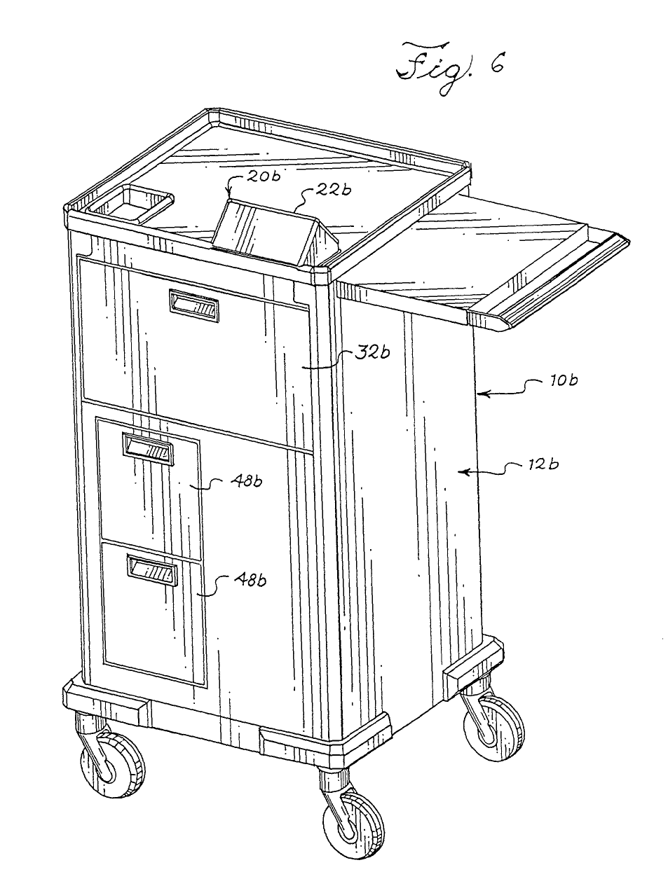

In FIG. 6, the cart lob has an upper narcotics drawer 32b and a pair of non-cassette, pharmaceutical bins or drawers 48b. An electronic operator 20b having a keypad 22b and a controller or computer controls the locking system that may be the same as described above to allow unlocking of the narcotics drawer separately from the unlocking of the pharmaceutical drawers. In FIG. 7, the medical cart 10c is similar to the cart lob of FIG. 6; but it is wider in width.

It is preferred that the user of the medical cart have a simple manner of relocking the drawers after having opened one or more of the drawers and removed pharmaceuticals and/or narcotics from the opened drawers. To this end, there is provided a lock operator 103 preferably in the form of a “lock” operator such as a “lock” push button 104 that operates a switch connected to the CPU to cause the locking operation by operating the electric drive for the locking devices. The above-described timed out locking operation is a fail safe in the event that if the user does not push the push button 104 after accessing a slidable drawer, and closes the drawer, the drawer will later be automatically locked when the timer times out upon expiration of the time period, the CPU causes operation of the motor to shift the lock bars and lock rods to the lock position. Herein, the control panel 21, in accordance with the invention, comprises the key pad 22 having numbered push buttons 102 that must be pushed with the proper pre-programmed code to send the proper signals to the computer 99 to cause it to unlock the slidable drawers. The control panel 21 also includes a lock operator preferably in the form of a push button 104 that upon operation sends a signal to the CPU that causes the computer 99 to initiate the locking operation by activating the electric motor that shifts the lock bars to their locked position. Those slidable drawers in their closed position are locked immediately and those in the open position will be locked when they are slid to the closed position.

Herein, the electrical power source may include a battery 109 (FIG. 12) and there is provided a low battery light 108 on the control panel to indicate when the battery power is low.

Preferably, there is also provided an audit port 110 whereby the computer 99 may be accessed to determine who, when, and how often the proper preprogrammed codes were used, particularly to gain access to the narcotics drawer. A suitable read out device is connected to the audit port 110 to interrogate the computer. Particularly with narcotics or other medications, management may want to have audit trails to know who had access to the narcotics and when. In accordance with another important aspect of the invention, each person may have an identifying code and the memory store 114 (FIG. 12) may store the personalized identity code, the date, and time of the person's access to the narcotics bin for later read-out. In the preferred embodiment of the invention, there is a readout, audit port 110 on the control panel 21 that connects to the memory store 114 and the computer and allows readout of the person, the date and time of access to the narcotics drawer and/or other medication drawers to provide the desired audit trail. The pre-programmed code inputted by the person preferably identifies the person as well as causes an unlocking operation of the drawers when a proper pre-programmed code is inputted. The computer causes entry into the memory data for storing the identity of the bin accessor, the date and the time for each access to medications an/or narcotics.

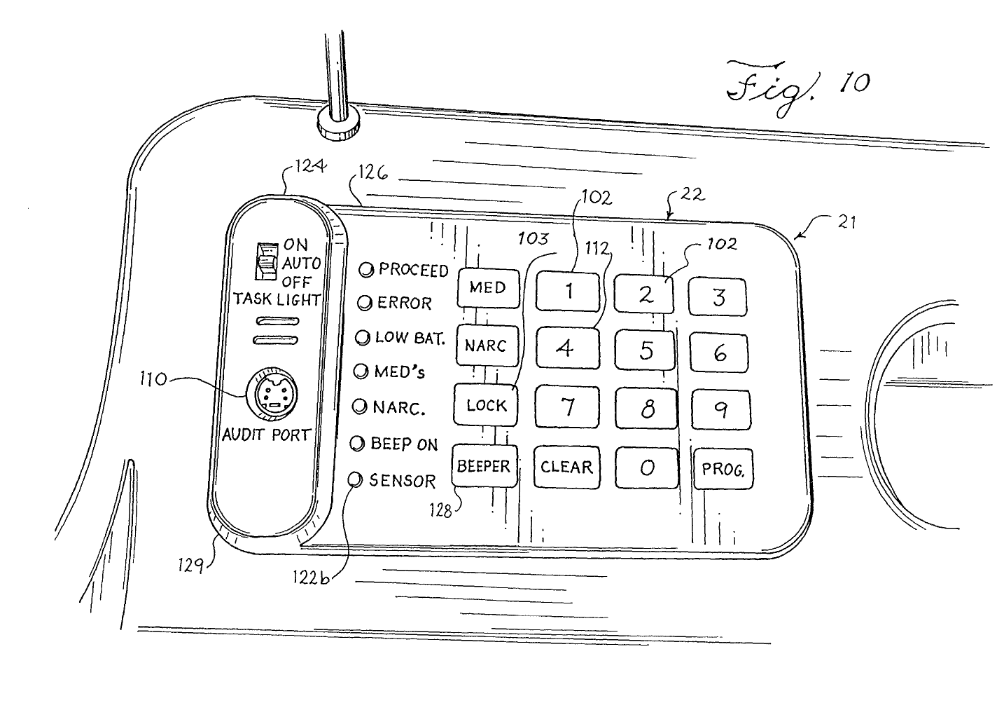

In accordance with an important aspect of the invention, the medical cart is provided with a light source 120 that illuminates the control panel 21 and medication and narcotic bins to allow identification and removal of the medicine in a darkened hospital room. Thus, the patient need not be awakened by turning on the room light. Preferably, the light source is also controlled automatically by sensor 122 such as a motion sensor 122a that detects movement of the cart and automatically switches on the light when the cart is put in motion and when the light switch 124 is positioned for automatic control. Another sensor may be a light level sensor 122b such as a photo cell device that senses the ambient light level and switches the light source on when entering a dark room and switches the light source off when moving into an ambient bright light area. The light level sensor may be an optical cell that is located on the control panel 21, as best seen in FIG. 10.

As best seen in FIG. 10, there is a task light switch 124 that is movable among an upper “on” switch position in which the light 120 is lit and a lower “off” position where the light is “off.” A third intermediate central position is labeled “auto”; and when the switch 124 is in the “auto” position, the light is under control of the sensors 122a or 122b.

The control panel 21 also has a low battery light 126 that is lit when the battery is low. The battery is carried on the cart and the housing has an access port for allowing connection of the battery to a battery charger when the light 126 is lit.

A beeper push button 128 may be pushed to cause a beep to be signaled each time a push button is operated to operate a switch associated therewith. The beeper provides an audio signal to the user that the push button has been pushed sufficiently to operate an associated switch so that the code will be entered properly. Lack of a beep means that a numerical push button switch was not operated sufficiently to enter that numeral into the CPU. A “beep on” light is lit when the beeper push button has been operated to activate the beeper. If the beeper push button is not pushed, the beeper light 129 remains unlit and there is no sound when a numeral push button is pushed.

In the preferred use of the control panel 21, the operator is provided with the operator's identity code, e.g., numerals 5 and 6 and with a code for entry into a medical drawer, e.g., 829. The operator can gain access to the medication drawers by first depressing a medication push button 132 on the control panel and then pressing the pre-programmed code 5, 6, 8, 2, 9 push buttons in that order. This inputted code is also recorded in the memory store and is recognized by the CPU operated motorized locking system to unlatch the medication drawers only. To gain access to the narcotics drawer, the operator not only presses the above-described codes above for turning the cam shaft through 135° but also depress a “NARC” button 133 followed by another preprogrammed narcotic code, e.g., 2, 6, 9, 1. Operation of the push buttons “2”, “6”, “9” and “1”, in that sequence causes the CPU to recognize a proper code for narcotics dispensing and to cause the motor to turn the cam shaft another 135° for a total of 270° that lifts both latch lifters thereby unlocking the narcotics drawer. Thus, it will be seen that operator has operated the “med” push button, numerals 5, 6, 8, 2 and 9 push buttons, the “narc” push button, numerals 2, 6, 9, 1 push buttons to unlatch the narcotics drawer in this example. Manifestly the codes may be different for different people or the same code with each person having a pin number that identifies the person unlocking the drawers and the manner of coding may differ substantially from that described herein, which is only one of the many kinds of coding operations that could be used and all within the purview of this invention.

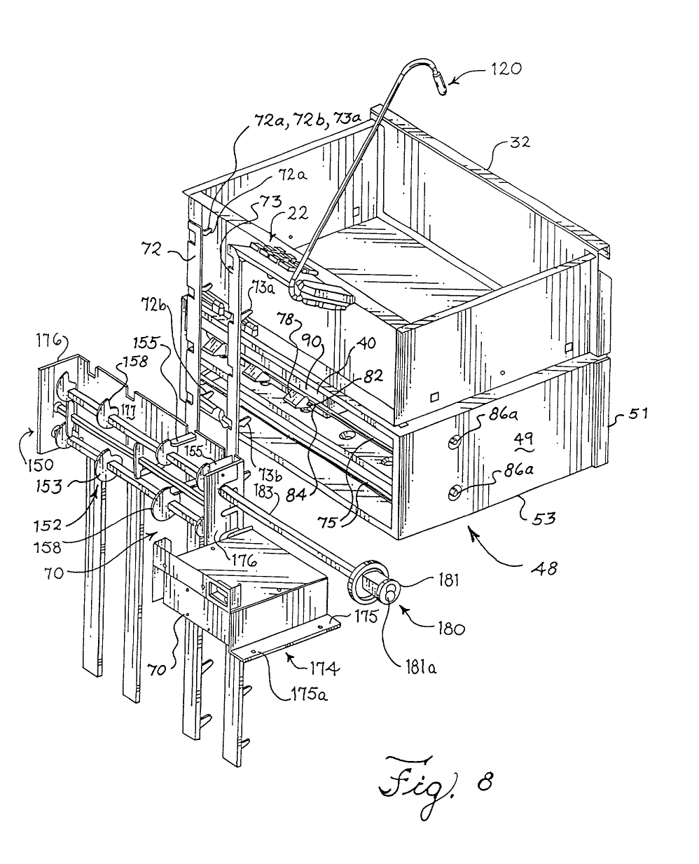

In the embodiment of the invention shown in FIG. 8, the locking mechanism 150 comprises electric drive in the form of an electric motor 151 connected to an end of a horizontally extending cam shaft 152 having a series of cams 153 thereon for moving the locking bars 72 and 73 that in turn operates locking rods 75 to unlatch the bins or drawers 40. The electric drive could be other forms than an electric motor such as electrically operated solenoids or the like. More specifically, the electric motor 151 turns the cam shaft 152 to turn through a predetermined amount, e.g., 135° causes the cams to push upwardly rearwardly extending cam follower projections 155 on the lock bars 72 and 73 thereby raising upwardly the lock bars to their unlocking position at which forward latch lifting projections or pins 72a, 73a located underneath the lock rods 75 push the lock rods 75 upwardly to rotate about pivot ends 86a in sidewalls 40 of the cassettes 48. As the locking rods pivot upwardly, their latching rod portions 84 raise from latching engagement in the slots 82 in the wedge-shaped latch members or blocks 78 projecting rearwardly from the slidable bins 40. So long as the lock bars 72 and 73 remain raised and the locking rods 75 are pivoted upwardly to the unlatching position, the medication bins 40 may be slid to the open position to provide access to the medications in the respective bins 40.

Upon depression of the lock bar push button 104, the CPU causes the motor drive 70 to reverse rotation of the cam shaft 152 through the same increment, e.g., 135° whereby the spirally-shaped cams turn and the cam follower projections 155 on the lock bars 72 and 73 are lowered to their stop position shown in FIG. 8 where the rearward end of the cam follower projection 155 abuts a vertical shoulder 158 at the end of the spirally-shaped cam. The lock bars may be biased downwardly, as by springs (not shown), and the locking rods 75 may also be spring biased to turn down about their pivot ends 86a to assure the travel downwardly with the lifter pins 72a and 73a against which they rest and thereby lower their latch rod portions 84 into aligned slots 82 on the latch members 78 for those bins in the closed positions. In the lock closed position, the bin's latch block has its slot 82 aligned to and receives therein a rod portion 84 of the locking rod 75. If someone tries to pull on the outer handle of a locked bin 40, the latch member 84 of the bin is held by its engaged rod portion against sliding forwardly.

As explained above, the wedge-shaped surface on the latch member 84 allows a bin to be shoved to its closed lock position, at any time, that the locking rod 75 is lowered into the locking position.

The illustrated locking system is formed with easily replaceable modules or units for replacement if a unit should fail. For example, the CPU, motor and battery (not shown) are mounted in a module 174 that is mounted in the housing by horizontal mounting brackets 175 in the form of horizontally extending flanges 175 that are secured by mechanical fasteners at hole locations 175a in the flanges. Likewise, the cam shaft and cams 153 are in a module having vertical end walls 176 and a front wall 177 that is secured by fasteners to the housing. This electrical module can be easily replaced if there is a problem with the cams or cam shaft. Also, the lock bars 72 and 73 can be easily replaced. The cam shaft, lock bars, and pivoted locking rods result in an inexpensive and simple locking system that is also a relatively low maintenance item.

In some instances if there is a power failure, it may be desired to have a mechanical access to the medications including narcotics in the bins because the keypad or, the CPU are not working or for whatever reason. Herein, there is a mechanical override system 180 that includes a key operated lock 181 have a key slot 181a to receive a key. The key lock is connected at its inner end to a cam shaft 183 parallel to the motor driven cam shaft 152. This override cam shaft has spirally-shaped cams 184 thereon similar to the cams 153 on the motorized cam shaft. The cam shaft 183 has spirally-shaped cams 184 thereon similar to the cams 153 on the motorized cam shaft 152. The cams 183 have spirally-shaped, outer cam surfaces bearing on the underside of rearwardly extending, cam follower projections 185 on the locking bars 72 and 73. The override cam follower projections 185 are located above the cam follower projections 155 that are lifted by the motor driven cams 153. The turning of the override shaft 183 through 135° causes the same lifting of the locking bars 72, 73 as done by a 135° rotation of the motor driven cam shaft 152 to unlatch the bins for removal. A rotation of the override cam shaft 183 through 270° by the key lock unlocks the narcotics bin. Thus, it will be seen that a mechanical system may be provided to operate the locking mechanism. If a less expensive, all mechanical system is desired, then the CPU, battery and electric motor need not be provided and the motor driven, cam shaft 152 and its cams 153 may also be eliminated.

What is claimed is:

1. A medical cart for holding pharmaceuticals or the like and narcotic kind of contents comprising:
a cart frame;
slidable drawers mounted in the cart frame and slidable to an open position to provide access to pharmaceuticals or like contents therein and a closed position within the cart frame denying access to the contents;
at least one slidable narcotics drawer mounted in the cart frame and slidable to an open position to provide access to narcotics therein and a closed position within the cart denying access to the narcotics;
a first locking device for locking the slidable drawers in their closed position;
a second locking device for locking the narcotics drawer in its closed position;
a keyless electronic operator for operating upon entry of a first code the first locking device to allow the slidable drawers to be unlocked and to be shifted to their open position to dispense the contents therein and for operating upon entry of another code the second locking device to allow the narcotics drawer to be opened.

2. A medical cart in accordance with claim 1 comprising:
an automatic relocking timer for automatically relocking the drawers upon expiration of a predetermined period of time.

3. A medical cart in accordance with claim 1 comprising:
a memory store for storing the entry codes of the persons trying to access the drawers;
an audit readout for reading out a log of entries.

4. A medical cart in accordance with claim 1 comprising:
an audit readout for allowing the logged entries to be printed out.

5. A medical cart in accordance with claim 1 comprising:
a rechargeable battery on the cart for supplying electrical power.

6. A medical cart in accordance with claim 1 comprising:
a manually operated override for operating the locking devices to allow the slidable drawers to be shifted to the open position independent of the electronic operator.

7. A medical cart in accordance with claim 1 wherein the electronic operator locks the narcotics drawer separately.

8. A medical cart in accordance with claim 1 wherein the electronic operator operates both the first and second locking devices to unlock the narcotics drawer.

9. A medical cart in accordance with claim 1 wherein a timer is associated with the electronic operator to cause an automatic locking after expiration of a predetermined period of time, of the first and second locking devices to their locking position.

10. A medical cart in accordance with claim 1 wherein the locking device comprises cooperating locking elements that allows the slidable drawers to be slammed to a closed position causing the cooperating locking elements to lock drawers in the locked position.

11. A medical cart in accordance with claim 10 wherein one of the cooperating locking elements has a camming portion for displacing the other locking element when slammed there against to allow them to shift to their locking condition.

12. A medical cart in accordance with claim 1 wherein electronic operator comprises a keypad and twin motor drives; and
the first and second locking devices comprise a motor driven actuator and locking rods shifted by the motor between locking and unlocking positions.

13. A medical cart in accordance with claim 12 wherein the motor driven actuator comprises a vertically movable lock bar having spaced projections positioned thereon to shift the locking rods to the unlocked position.

14. A medical cart in accordance with claim 13 comprising:
pivot mounts for pivotally mounting the locking rods to pivot when actuated by the lock bar.

15. A medical cart in accordance with claim 1 wherein a cassette mounted in the cart frame carries rows of slidable drawers which are in the form of plastic bins.

16. A medical cart in accordance with claim 15 wherein:
the electronic operator comprises an electrical input device operable with a first input code to shift the first locking device to an inoperative, non-locking position and operable with a second code to shift the second locking device to an inoperable, non-locking position.

17. A medical cart in accordance with claim 16 wherein:
the locking devices comprise lock bars shiftable from an operative locking position to an inoperative, non-locking position.

18. A medical cart in accordance with claim 1 wherein the electronic operator comprises:
a keypad operable by an operator to input codes to access the narcotics and pharmaceutical drawers;
a CPU for receiving signals from the keypad; and
a motor drive selectively controlled by the CPU to shift the locking devices upon the input of the proper access codes into the CPU.

19. A medical cart in accordance with claim 1 wherein a lock push button is provided on the cart for causing the electronic operator to lock the slidable drawers.

20. A medical cart in accordance with claim 1 wherein:
wheels are provided on the cart for moving the cart from one location to another location.

21. A medical cart for holding pharmaceuticals or the like and narcotics comprising:
a cart frame;
slidable drawers mounted in the cart frame and slidable to an open position to provide access to pharmaceuticals or like contents therein and a closed position within the cart frame denying access to the contents;
at least one slidable narcotics drawer mounted in the cart frame and slidable to an open position to provide access to narcotics therein and a closed position within the cart denying access to the narcotics;
a keyless operated locking device for selectively locking and unlocking the respective drawers upon the proper input of preprogrammed codes; and
an automatic locking timer operable after the elapse of a predetermined period of time to operate the locking device to lock the drawers when in the closed position.

22. A medical cart in accordance with claim 21 comprising:
a control pad having a keypad to input codes and a lock push button to cause the electronic operated device to lock automatically to lock the drawers when in their closed position.

23. A portable medical cart for dispensing medications and narcotics, comprising:
a cart housing,
medication drawers in the housing movable from a closed position to an open position to allow access to medications therein;
at least one narcotic drawer in the housing movable from a closed position to an open position to allow access to narcotics therein;
a locking mechanism for the medication drawers and the narcotics drawer to lock the respective drawers in their closed position; and
an electronic operator operable by input of a first pre-programmed code to actuate the locking mechanism to unlock the medication drawer for removal of a medication and by input of a second pre-programmed code to actuate the locking mechanism to unlock the narcotic drawer to allow removal of narcotics from the narcotic drawer.

24. A portable medical cart in accordance with claim 23 comprising:
a memory store in the cart for storing information from the user gaining access to the narcotic drawer; and
a readout port to allow readout of the stored information to provide an audit trail with respect to access to the narcotics in the narcotic drawer.

25. A portable medical cart in accordance with claim 23 wherein the memory store is associated with a CPU and stores the identity of the person accessing the narcotics drawer, the time of access, the date of access for read-out to provide an audit trail.

26. A portable cart in accordance with claim 23 comprising:
a CPU in the medical cart;
wheels on the housing for wheeling the cart to various locations; and
a battery source in the cart for providing electrical power for the power for the CPU and electrical operator.

27. A medical cart in accordance with claim 23 comprising:
a light source for illuminating the contents of an opened drawer and the electronic operator to allow use of the cart in a darkened hospital room.

28. A medical cart in accordance with claim 27 comprising:
a control switch device for the light source for turning the light on and off and for placing the light source under automatic control.

29. A medical cart in accordance with claim 28 comprising:
a timer for shutting off the light at a predetermined time under the automatic control

30. A medical cart in accordance with claim 28 comprising:
a motion sensor for sensing movement of the cart and turning on the light source to illuminate the path of movement for the portable medical cart.

31. A medical cart in accordance with claim 23 comprising:
a locking mechanism having vertical movable locking members to unlock a plurality of drawers; and
a motor driven shaft and cams on the shaft to shift the locking members to unlock the drawers.

32. A medical cart in accordance with claim 31 comprising:
latch members operable by the locking members to unlatch from a plurality of drawers held latched by each latch member until operated by one of the locking members.

33. A medical cart in accordance with claim 32 wherein:
a latch on the drawers is operable to move into locking engagement with a latching member upon the drawer being closed after having been opened.

34. A medical cart in accordance with claim 23 comprising:
a key operated device to shift the locking mechanism to an unlocking position to allow opening of the drawers.

35. A medical cart in accordance with claim 34 comprising:
a turnable shaft turned by the key operated device to shift the locking mechanism to allow the opening of all of the drawers independently of the electronic operator.

36. A medical cart for holding pharmaceuticals or the like and narcotics comprising:
a cart frame;
slidable drawers mounted in the cart frame and slidable to an open position to provide access to pharmaceuticals or like contents therein and a closed position within the cart frame denying access to the contents;
at least one slidable narcotics drawer mounted in the cart frame and slidable to an open position to provide access to narcotics therein and a closed position within the cart denying access to the narcotics;
a locking mechanism including vertically movable locking members;
latching members for the locking mechanism and shiftable by the vertically movable locking members to unlatch the drawers to allow access to the drawers;
a turnable cam shaft for the locking mechanism having cams thereon turnable to operate the vertical movable locking members; and
a key operator turnable by a person to turn the cam shaft and to operate the locking mechanism to allow access to the contents in the drawers.

37. A medical cart in accordance with claim 36 comprising:
a replaceable cam shaft module having the cam shaft mounted therein for replacement with another cam shaft module in the event of a problem with the cam shaft or cams therein.

38. A medical cart in accordance with claim 37 comprising:
a replacement electronics module connected to the cam shaft module for replacement in the event of a problem with the electronics.
